(19) United States
(12) Patent Application Publication
(10) Pub. No.: US 2003/0029406 A1
(43) Pub. Date: Feb. 13, 2003

(54) Arrangement for automatically switching on and switching off an internal combustion engine

(76) Inventor: Ruediger Weiss, Moetzingen (DE)

Correspondence Address: Walter Ottesen, Patent Attorney, P.O. Box 4026, Gaithersburg, MD, 20885-4026, US

(21) Appl. No.: 10/216,391

(22) Filed: Aug. 12, 2002

(30) Foreign Application Priority Data
Aug. 11, 2001 (DE) 101 39 595.7

(51) Int. Cl. H02G 3/00

(52) U.S. Cl. 123/179.4; 307/10.6

(57) ABSTRACT

An arrangement for automatically switching on and switching off an internal combustion engine of a motor vehicle includes a first sensor system for detecting an operating state of at least one of the internal combustion engine and the motor vehicle; a second sensor system for detecting a traffic situation in the surroundings of the motor vehicle; and, a control apparatus for switching the internal combustion engine on and/or off in dependence upon the operating state and the traffic situation.

### FIELD OF THE INVENTION

The invention relates to an arrangement for automatically switching on and/or switching off an internal combustion engine of a motor vehicle. The arrangement includes means for detecting an operating state of the engine and/or of the motor vehicle and a control apparatus. The control apparatus switches the engine on and/or off in dependence upon the operating state.

The invention relates furthermore, to an internal combustion engine of a motor vehicle which can be automatically switched on and/or switched off. The engine includes an arrangement for automatically switching on and/or switching off the engine. The arrangement includes means for detecting an operating state of the engine and/or of the motor vehicle and a control apparatus which switches on and/or switches off the engine in dependence upon the operating state.

Finally, the invention relates to a method of automatically switching on and/or switching off an engine of a motor vehicle wherein an operating state of the engine and/or of the motor vehicle is detected and the engine is switched on and/or switched off in dependence upon the operating state.

### BACKGROUND OF THE INVENTION

German patent publication 4,421,512 discloses an arrangement for automatically switching on and switching off an internal combustion engine of the kind described initially herein. The fuel supply is interrupted for switching off the engine. A renewed switch-on of the engine takes place by resuming the supply of fuel and by actuating a starter in order to impart a rotational movement to the engine at the beginning of the starting operation. The operating state of the engine is detected in the known arrangement based on the following: the crankshaft rpm and transmission input rpm, the position of the clutch pedal and the position of an accelerator pedal. The control apparatus decides whether the engine is switched off or again switched on in dependence upon the detected operating state.

In the above-mentioned publication, six operating states of the engine are mentioned. The decision whether the engine is switched off or again switched on is made by the control apparatus exclusively in dependence upon the detected operating variables and/or in dependence upon the operating state of the engine.

A switch-off of the engine takes place, for example, if the idle operation exceeds a time-dependent threshold value. Here, it cannot be recognized by the control apparatus whether a string of vehicles (in which the vehicle stands) is again set in motion shortly before exceeding the threshold value and the switch-off of the engine in this situation would actually not be purposeful. In the state of the art, considerations of this kind of the traffic situation in the surroundings of the motor vehicle are not taken into account. The actual objective of the automatic switch-off of the engine of a motor vehicle (namely, a reduction of the fuel consumption and of the exhaust-gas discharge) can be turned into the reverse situation because the switch-off and the renewed switch-on of the engine directly thereafter leads to a considerable fuel consumption and to an especially high discharge of exhaust gas.

The engine is switched on, for example, by pressing the accelerator pedal in combination with additional safety inquiries, such as “brakes not depressed” or “clutch not engaged”. In order to realize an as fast possible switch-on of the engine and starting movement of the vehicle, the vehicle has either a powerful electric motor (so-called starter generator) so that the vehicle (for example, in a string of vehicles in city traffic) can start to move electrically and the internal combustion engine is thereby started. Alternatively, the motor vehicle has a conventional starter whereby decelerations can occur when moving the vehicle away from standstill because, at first, a command for again starting the engine is recognized and the engine must be switched on before the vehicle can start moving. The deceleration operates especially disturbingly in bumper-to-bumper traffic because a uniform flow of traffic is thereby impossible.

### SUMMARY OF THE INVENTION

It is an object of the invention to optimize the automatic switch-on and switch-off of an internal combustion engine of a motor vehicle so that an unnecessary switch-off of the engine is avoided and an early renewed switch-on of the engine is made possible.

The above object is realized by the invention starting with an arrangement for the automatic switch-on and switch-off of an engine of the above-mentioned type in that the arrangement includes additional means for detecting a traffic situation in the surroundings of the motor vehicle and the control apparatus switches the engine on and off also in dependence upon the traffic situation.

An unnecessary switch-off and a renewed switch-on of the engine directly thereafter can be prevented with the switch-off of the engine of a motor vehicle in accordance with the invention with the switch-off being dependent upon the traffic situation. This leads, on average, to a reduced consumption of fuel and to reduced emissions of exhaust gas. Furthermore, the engine can be started early automatically, for example, in bumper-to-bumper traffic with the arrangement according to the invention. This is so because an expressive command of the driver such as actuating the accelerator pedal must not be awaited to start the engine. A vehicle, which is equipped with the arrangement of the invention, having a switch-on and switch-off function for the engine can be started automatically when a movement of the vehicle directly ahead is detected. In this way, the vehicle participates fluidly in the traffic.

The conversion of a motor vehicle without such a switch-on and switch-off function of the engine to a motor vehicle with such a function is considerably facilitated by the arrangement of the invention. This ultimately leads to a clearly higher acceptance of such an automatic switch-on and switch-off function for the engine of a motor vehicle by the drivers.

For the decision as to whether the internal combustion engine should be switched on or switched off, the control apparatus can, in addition to the operating state of the engine and/or of the vehicle, also consider the traffic situation in the total surroundings of the motor vehicle. It is, for example, conceivable to again start the engine on a multi-lane street when the traffic in the adjacent traffic lanes (in the same direction) starts to move.

The invention is usable for a motor vehicle having a standard transmission in the same manner as for a vehicle having an automatic transmission. In a standard transmission, information as to the operating state of the transmission is determined based on clutch sensors and, in an automatic transmission, this information is supplied by a transmission control to the control apparatus to switch off and/or switch on the internal combustion engine.

According to an advantageous further embodiment of the invention, it is, however, suggested that the additional means detect the traffic situation in the travel direction in front of the motor vehicle. In this region, the traffic situation is of special significance for an automatic switch-off or switch-on of the engine because the detection of the traffic situation ahead of the vehicle permits an advance decision as to the switch-on and switch-off of the engine.

According to a preferred embodiment of the invention, it is provided that the further means determines the distance from the present motor vehicle to a further motor vehicle leading the present motor vehicle as a traffic situation. To determine the distance to a leading motor vehicle, preferably sensors of a distance control (by means of ultrasonic sound, optics or by means of radar) are utilized with which a motor vehicle is equipped for parking or as an electronic drawbar to the leading motor vehicle.

In an advantageous manner, the further means determine a speed of a leading motor vehicle disposed ahead of the present motor vehicle as a traffic situation. From the distance between the present motor vehicle and the leading vehicle together with the speed of the present motor vehicle, the speed of the leading motor vehicle can be determined. If the determined motor vehicle speed exceeds a pregivable threshold value, the engine is again switched on. The threshold value can be selected in dependence upon the inclination of the roadway under the motor vehicle. In this way, for standstill of the motor vehicle in a climb, a conclusion can be drawn as to a start-to-move situation when there is a slight movement of the additional motor vehicle. If such a start-to-move situation is detected, then (if necessary, after enabling of different safety interrogations), the engine is started so that an acceleration of the motor vehicle is immediately possible with the actuation of the accelerator pedal.

According to a further advantageous embodiment of the invention, it is suggested that the additional means determine a switching cycle of a traffic control (open loop and/or closed loop) system as a traffic situation. The traffic control system can be a traffic light, a traffic directing system, a warning light at a railway crossing or the like. Advantageously, the additional means includes optical sensors having an image processing device connected thereto. The traffic situation can be detected and evaluated by means of optical sensors by evaluating the optical signals of the traffic control system. Alternatively, the traffic control systems can, however, also actively transmit signals concerning their switching cycle and these signals can be received by suitable means in the motor vehicle and be evaluated in the control apparatus. The transmission of the signals can take place via a direct radio connection, infrared connection or ultrasonic connection or via a telecommunications connection.

According to a further preferred embodiment of the invention, it is suggested that the arrangement detect the inclination of the roadway on which the motor vehicle stands and the control apparatus switches the internal combustion engine on and off also in dependence upon the roadway inclination. The inclination of the roadway can be determined by means of an inclination sensor or by evaluation of various operating variables of the engine or of the motor vehicle.

As a further solution of the object of the invention, and starting from the internal combustion engine of the type mentioned initially herein, it is suggested that the arrangement includes additional means for detecting a traffic situation in the surroundings of the motor vehicle and the control apparatus switches the engine on and off also in dependence upon the traffic situation.

As a still further solution of the object of the invention, and starting from the method for automatically switching on and switching off the engine of the type initially mentioned herein, a traffic situation is detected in the surrounding of the motor vehicle and the engine is switched on and switched off also in dependence upon the traffic situation.

### BRIEF DESCRIPTION OF THE DRAWINGS

The invention will now be described with reference to the drawings wherein:

FIG. 1 is a schematic of a preferred embodiment of the internal combustion engine of the invention of a motor vehicle having an arrangement for automatically switching on and switching off the internal combustion engine;

FIG. 2 is a flowchart showing the method of the invention for automatically switching off an internal combustion engine of a motor vehicle in accordance with a preferred embodiment; and,

FIG. 3 is a flowchart of a method according to the invention for automatically switching on an internal combustion engine of a motor vehicle in accordance with a preferred embodiment.

### DESCRIPTION OF THE PREFERRED EMBODIMENTS OF THE INVENTION

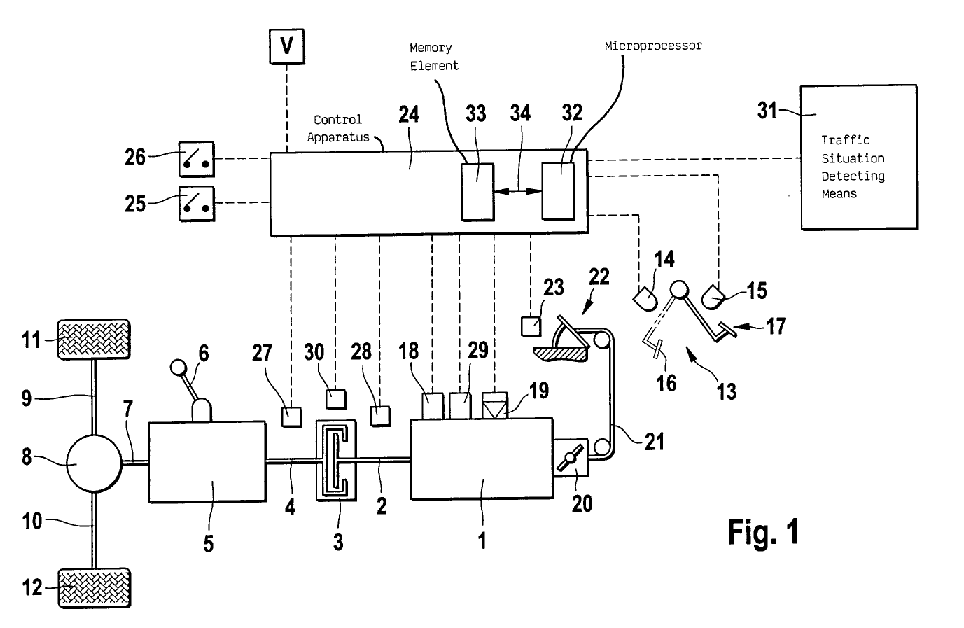

In FIG. 1, reference numeral 1 identifies an internal combustion engine of a motor vehicle. A crankshaft 2 of the engine 1 is connected via a clutch 3 to a transmission input shaft 4 of a transmission 5. The transmission 5 is configured as a manual transmission which is provided with a gear selection lever 6. A transmission output shaft 7 is downstream of the transmission 5 and is connected to a differential transmission 8. Axle shafts (9, 10) with vehicle wheels (11, 12) extend from the differential transmission 8.

The clutch 3 is located between the engine 1 and the transmission 5 and is actuated mechanically by the deflection of a clutch pedal 13 which is connected to the clutch 3 via an actuating member (not shown). The actuating member can, for example, be a pull cable, Bowden cable or an electrical signal line and actuating device. Clutch pedal sensors (14, 15) are assigned to the clutch pedal 13 and are configured as end-position sensors. With the clutch pedal sensors (14, 15), the deflected positions (16, 17) of the clutch pedal 13 are determined. Alternatively, a clutch potentiometer (not shown) known per se can be utilized in lieu of the end-position sensors. With the clutch potentiometer, the deflected positions of the clutch pedal 13 can be exactly determined in all positions.

A starter 18 is assigned to the engine 1 in order to impart an initial rotational movement to the engine 1 when switching on or starting. Furthermore, the engine 1 is connected to a fuel pump 19 with which fuel can be supplied via a fuel line from a fuel supply vessel (not shown). The fuel can be injected into an intake manifold or directly into the combustion chambers of the engine 1. Finally, a power actuator 20 is provided on the engine 1 and is connected to an accelerator pedal 22 and, in the case of a mechanical actuation, this connection can be via a pull line 21. The power actuator 20 is, for example, configured as a throttle flap or as a gasoline injection pump. In addition to the mechanical connection between the accelerator pedal 22 and the power actuator 20, an electrical signaling of the power command via a sensor 23 on the accelerator pedal 22 and a control apparatus 24 are conceivable. In this case, the control apparatus 24 is connected to the power actuator 20 via a control line (not shown).

The control apparatus 24 comprises essentially a microcomputer which has a microprocessor 32 and at least one memory element 33 which can, for example, be configured as a flash memory. A computer program is stored on the memory element 33 which is suitable for running on the microprocessor 32 and for carrying out the method of the invention. For executing the computer program, this program is either transferred as a whole or per command to the microprocessor 32 via a data transmission connection 34. The control apparatus 24 functions to control (open loop and/or closed loop) a switch-on function and a switch-off function of the engine 1 of the motor vehicle. The switch-on and switch-off functions can be manually activated or deactivated by actuating a switch 25. A further switch 26 is connected to the control apparatus 24 and functions for manually switching on and switching off the engine 1 and is, for example, configured as a starter knob or as an ignition switch.

The control apparatus 24 is connected via sensor lines and/or control lines (shown as broken lines in FIG. 1) to the following: the accelerator pedal sensor 23; the starter 18; the fuel pump 19; an rpm sensor 27 on the transmission input shaft 4; an rpm sensor 28 on the crankshaft 2; the clutch pedal sensors (14, 15); and a temperature sensor 29 on the engine 1. Furthermore, the control apparatus 24 is connected to a clutch sensor 30 via a sensor line for transmitting the actuating state of the clutch.

The invention is suitable for a motor vehicle having a manual transmission 5 in the same way as for a motor vehicle having an automatic transmission. For a manual transmission, information is determined via the operating state of the transmission 5 based on clutch sensors 30 and in an automatic transmission, this information is supplied, for example, by a transmission control to the control apparatus 24. The transmission control can communicate with the control apparatus 24 in such a manner that, for a motor vehicle having an automatic transmission, the transmission is brought into a park position (usually the position “P”) in advance of switching off the engine 1.

Furthermore, means 31 are provided for detecting a traffic situation in the surroundings of the motor vehicle and this means is connected to the control apparatus 24 via a sensor line for transmitting the traffic situation. The means 31 includes, for example, sensors of a distance control (for example, ultrasonic sensors or radar sensors), optical sensors having an image processing unit connected thereto or sensors configured in any other desired manner for detecting the traffic situation in the surroundings of the motor vehicle. The means 31 detect preferably the traffic situation in the driving direction ahead of the motor vehicle.

As a traffic situation, for example, the distance from the present motor vehicle to a further vehicle (leading vehicle), which is disposed in the direction of traffic ahead of the present motor vehicle, is determined. The speed of the leading vehicle can be determined from the distance of the present vehicle to the leading vehicle together with the speed of the trailing vehicle. As a traffic situation, the means 31 can also determine the switching cycle of a traffic control system. The traffic control system is configured, for example, as a traffic light, a traffic directing system, a signal system of a railway crossing or the like. For determining the switching cycle of a traffic control system, the means 31 can include, for example, optical sensors and an image processing system connected thereto or means for receiving a signal which is actively transmitted by the traffic control system and contains information about the switching cycle.

Whereas, in the embodiment of FIG. 1, the control apparatus 24 is a separate microcomputer, the switch-on and switch-off functions of the invention for the internal combustion engine 1 can also be accommodated in an engine control apparatus, which is present usually in motor vehicles of the present day or can be accommodated in any other desired control apparatus.

The sensors (14, 15, 23, 27, 28, 29, 30) function to detect an operating state of the internal combustion engine 1 and/or of the motor vehicle. The operating state is applied by the control apparatus 24 to make the decision as to whether the engine 1 is automatically switched off and/or should again be switched on. For example, in German patent publication 4,421,512, column 3, line 52, to column 6, line 28, six operating states are described based on which a decision is made to switch the engine 1 off and/or on again. German patent publication 4,421,512 is incorporated herein by reference.

According to the invention, it is suggested that, in addition to the operating state of the engine 1 and/or of the motor vehicle, also the traffic situation in the surroundings of the motor vehicle is utilized in the decision as to whether the engine 1 should be switched off and/or be switched on again. For this purpose, means 31 is provided for detecting the traffic situation. By considering the traffic situation, an unnecessary switch-off of the engine 1 can be avoided and an early switch-on of the engine 1 is made possible so that, on the one hand, the fuel consumption and the exhaust-gas emissions can be reduced and, on the other hand, a fluid participation in bumper-to-bumper traffic is possible. Furthermore, with the automatic switch-on and switch-off function of the invention, a conversion from a conventional motor vehicle without such a function to a motor vehicle having such an automatic switch-on and switch-off function is clearly facilitated for a driver of the vehicle whereby the acceptance of motor vehicles having such a function is significantly increased.

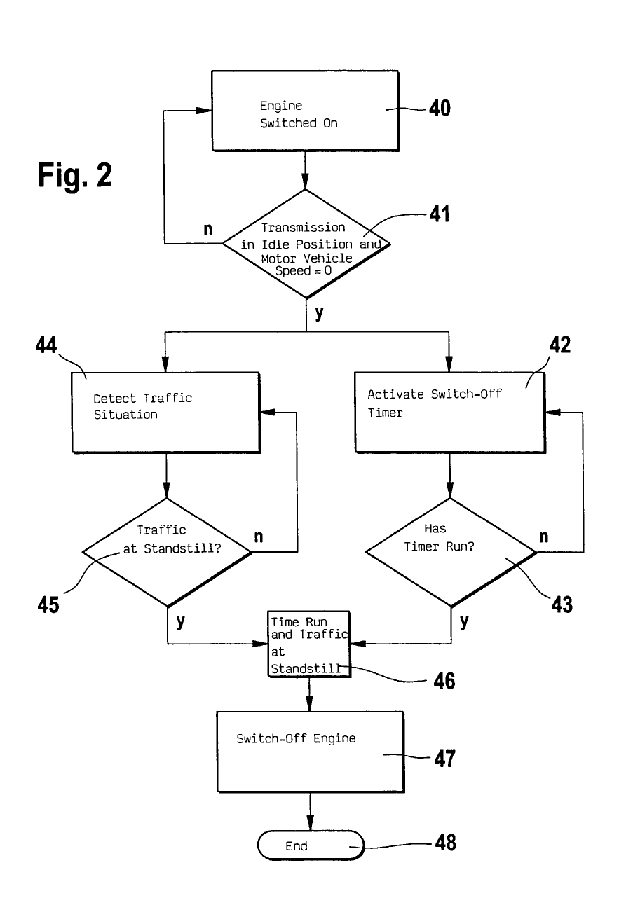

FIG. 2 shows a flowchart of an embodiment of the method of the invention for automatically switching off the internal combustion engine 1. The method begins in a function block 40 with a switched-on engine 1. In a next interrogation block 41, a check is made as to whether the transmission 5 is in an idle position and whether the speed of the motor vehicle is equal to zero. If the response here is yes, then the conclusion can be drawn that the engine 1 is in an operating state which would permit a switch-off of the engine 1. In the event the response is no, the engine 1 continues to be operated.

In the event that the engine 1 is in an operating state wherein it could be switched off, then a switch-off timer is activated in a function block 42 and, in an interrogation block 43, a check is made as to whether the timer has run. Additionally, the traffic situation in the surroundings of the vehicle is detected in a function block 44 and, in an interrogation block 45, a check is made as to whether the traffic is at standstill, that is, especially whether additional motor vehicles traveling ahead of the present motor vehicle come to standstill. In the event that the timer has run and the traffic has come to standstill (function block 46), the engine 1 is switched off in function block 47. The method according to the invention is ended in a function block 48.

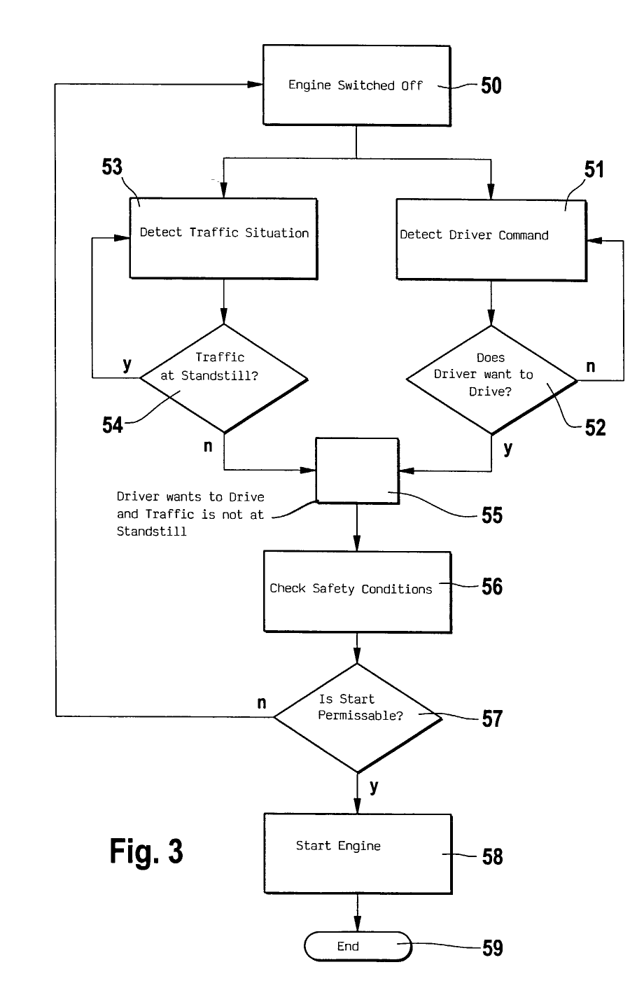

In FIG. 3, a flowchart is shown of a method of the invention for switching on the engine 1. The method begins in a function block 50 with a switched-off engine 1. Then, in a function block 51, the driver command is detected, for example, via an accelerator pedal sensor 23. In an interrogation block 52, a check is made as to whether the driver wants to drive. Additionally, in function block 53, the traffic situation in the surroundings of the motor vehicle is detected. In an interrogation block 54, a check is made as to whether the traffic is at standstill.

In the event that the driver wants to drive and the traffic is not at standstill (function block 55), a check is made in function block 56 as to safety conditions, for example, “transmission 5 in idle position” or “clutch pedal depressed”. In an interrogation block 57, a check is made as to whether the safety conditions are satisfied and a switch-on of the engine 1 is permitted. In the event that the safety conditions are, however, not satisfied, then the method branches again to function block 50 and the engine 1 remains switched off. In the event, however, that the safety conditions are satisfied, then the engine 1 is switched on in a function block 58 with the aid of the starter 18 by activating the fuel injection pump 19. The method of the invention is ended in function block 59.

It is understood that the foregoing description is that of the preferred embodiments of the invention and that various changes and modifications may be made thereto without departing from the spirit and scope of the invention as defined in the appended claims.

What is claimed is:

1. An arrangement for automatically switching on and switching off an internal combustion engine of a motor vehicle, the arrangement comprising:
first means for detecting an operating state of at least one of said internal combustion engine and said motor vehicle;
second means for detecting a traffic situation in the surroundings of said motor vehicle; and,
a control apparatus for switching said internal combustion engine on and/or off in dependence upon said operating state and said traffic situation.

2. The arrangement of claim 1, wherein said second means detects the traffic situation in the direction of travel ahead of said motor vehicle.

3. The arrangement of claim 2, wherein said motor vehicle is a present motor vehicle traveling at a distance behind a leading motor vehicle also moving in said direction of travel; and, said second means functioning to detect said distance between said present and leading motor vehicles.

4. The arrangement of claim 1, wherein said motor vehicle includes a distance control unit having sensors and said second means including said sensors.

5. The arrangement of claim 3, wherein said second means functions to detect, as said traffic situation, a speed of said leading motor vehicle.

6. The arrangement of claim 3, wherein said second means functions to determine a switching cycle of a traffic control system as said traffic situation.

7. The arrangement of claim 1, wherein said second means includes optical sensors with an image processing device connected thereto.

8. The arrangement of claim 1, further comprising means for detecting the inclination of a roadway on which said motor vehicle stands; and, said control apparatus functioning to switch said internal combustion engine on and off also in dependence upon said inclination of said roadway.

9. An internal combustion engine of a motor vehicle, which can be switched on and off automatically, the internal combustion engine comprising:
an arrangement for automatically switching on and switching off said internal combustion engine;
said arrangement including:
a control apparatus;
first means for detecting an operating state of at least one of said internal combustion engine and said motor vehicle;
second means for detecting a traffic situation in the surroundings of said motor vehicle; and,
said control apparatus for switching said internal combustion engine on and/or off in dependence upon said operating state and said traffic situation.

10. A method for automatically switching on and switching off an internal combustion engine of a motor vehicle, the method comprising the steps of:
detecting an operating state of at least one of said internal combustion engine and said motor vehicle;
detecting a traffic situation in the surroundings of said motor vehicle; and,
switching said internal combustion engine on and/or off in dependence upon said operating state and said traffic situation.
